(19) United States
(12) Patent Application Publication
(10) Pub. No.: US 2024/0428389 A1
(43) Pub. Date: Dec. 26, 2024

(54) IMAGE ANALYSIS METHOD AND SYSTEM FOR COMPUTER-IMPLEMENTED DETERMINATION OF THE DEGREE OF GRAIN CRACKING OF GRAINS

(71) Applicant: CLAAS Selbstfahrende Erntemaschinen GmbH, Harsewinkel (DE)

(72) Inventors: Dennis Neitemeier, Lippetal (DE); Sven Carsten Belau, Gütersloh (DE); Ingo Bönig, Gütersloh (DE); Markus Brune, Harsewinkel (DE); Marwin Klein Heimkamp, Bramsche (DE)

(73) Assignee: CLAAS Selbstfahrende Erntemaschinen GmbH, Harsewinkel (DE)

(21) Appl. No.: 18/751,494

(22) Filed: Jun. 24, 2024

(30) Foreign Application Priority Data
Jun. 22, 2023 (DE) 102023116409.0

(51) Int. Cl. G06T 7/00; A01D 43/08; A01F 11/06; G06T 7/60; G06V 10/764; G06V 10/82

(52) U.S. Cl. CPC G06T 7/0002; A01F 11/06; G06T 7/60; G06V 10/764; G06V 10/82; A01D 43/085; G06T 2207/20084; G06T 2207/30188

(57) ABSTRACT

An image analysis method and system for the computer-implemented determination of the degree of grain cracking of grains within a flow of harvested material processed by working units of a forage harvester. The flow of harvested material comprises whole grains and crushed grains as grain components and non-grain components. The at least one working unit is automatically controlled depending on the degree of grain cracking. Images of the flow of harvested material are cyclically recorded using an optical recording device and transmitted to an image analysis apparatus for evaluation. The image analysis apparatus, in a first stage classifies image pixels contained in the images into grain components and non-grain components, and in a second stage, determines a length of a long main axis and a short main axis of each classified grain component via a length-width comparison, with the first stage and the second stage performed by a neural network.

### CROSS REFERENCE TO RELATED APPLICATIONS

This application claims priority under 35 U.S.C. § 119 to German Patent Application No. DE 10 2023 116 409.0 filed Jun. 22, 2023, the entire disclosure of which is hereby incorporated by reference herein. The present application is related to U.S. Application No______. (attorney docket no. 15191-24011A (P05713/8), incorporated by reference herein in its entirety.

### TECHNICAL FIELD

The present application relates to an image analysis method and system for the computer-implemented determination of the degree of grain cracking of grains.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

US Patent Application Publication No. 2022/0061215 A1, incorporated by reference herein in its entirety, discloses a forage harvester which has working units for harvesting a crop and for processing harvested material from the crop. While the forage harvester is operating, the harvested material, which may comprise grain components and non-grain components, is transported in a harvested material flow through the forage harvester along a harvested material transport path. Image data of the harvested material in the flow of harvested material is recorded using an optical recording device that may comprise a camera. Using this image data, the composition of the flow of harvested material is divided into grain components and non-grain components in an image recognition routine using an image recognition algorithm in order to determine an indicator for a structural component of the harvested material from the geometric properties of the non-grain components according to a predetermined calculation rule.

US Patent Application Publication No. 2016/0029561 A1, incorporated by reference herein in its entirety, discloses an image analysis method for determining a degree of grain cracking of grains. Image data of the harvested material from the flow of harvested material is recorded and analyzed by an optical measuring system. For this purpose, grain-like particles (e.g., whole grains and grain components) contained in the flow of harvested material are identified. On the basis of this image data, the grain components are divided into crushed and non-crushed grain components and divided into quantitative size fractions. The ratio of the thickness of the size fractions is used to determine the degree of grain cracking in order to optimize the operation of the forage harvester.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a schematic of a forage harvester.

FIG. 2 illustrates a schematic and an example image of chopped harvested material recorded by the recording apparatus.

FIG. 3 illustrates a schematic and an example binary image of the image analyzed by an image analysis method according to FIG. 2.

FIG. 4 illustrates a schematic and an example enlarged section of the binary image according to FIG. 3.

FIG. 5 illustrates a schematic and an example evaluation of the binary image according to FIG. 3.

FIG. 6 illustrates a flow chart of the image analysis methodology.

FIG. 7 illustrates a schematic and an example representation of a graphical interface of an input/output unit of a driver assistance system.

### DETAILED DESCRIPTION

As discussed in the background, US Patent Application Publication No. 2016/0029561 A1 discloses an image analysis methodology in which the grain components are divided into crushed and non-crushed grain components and divided into quantitative size fractions. The ratio of the thickness of the size fractions is used to determine the degree of grain cracking in order to optimize the operation of the forage harvester. The measuring system works as an optical sieve. The distinction between crushed and non-crushed grain components is made on the basis of a defined limit value for the size of grain components, which, when used as animal feed, is oriented around the digestibility of the grain components. The physical properties of corn silage contribute significantly to the value of the crop when it is offered as feed. Properly processed grains (e.g., cracked grains) are well-digested and contribute to milk production, whereas poorly processed grains may pass through the cow undigested. The limit value for the size comparison is based on an empirically determined diameter for sieve openings that is used as standard in laboratory measurements for sifting processes, on the basis of which a static quality value for grain processing, the so-called corn silage processing score (CSPS), is determined. The image analysis disclosed in US Patent Application Publication No. 2016/0029561 A1 may be complex and may be inaccurate.

Thus, in one or some embodiments, a system and method are disclosed of performing image analysis that improves the accuracy of determining the degree of grain cracking of grains.

In one or some embodiments, an image analysis method is disclosed for computer-implemented determination of the degree of grain cracking of grains within a flow of harvested material processed by working units of a forage harvester, which may comprise whole grains and crushed grains as grain components as well as non-grain components. At least one working unit may be actuated depending on the degree of grain cracking, wherein images of the flow of harvested material may be cyclically recorded using at least one optical recording device may be transmitted (e.g., wired and/or wirelessly) to an image analysis apparatus for evaluation. The image analysis method may include:
in a first stage, image pixels contained in the images may be classified into grain components and non-grain components via digital image processing; and
in a second stage of the image analysis method, a length determination of a long main axis and a short main axis of one, some or each classified grain component is performed using a length-width comparison, wherein the implementation of the first stage and the second stage of the image analysis method may be performed by at least one neural network.

In one or some embodiments, optical sifting may react to changes that may already occur during the harvesting process on a field or between two harvesting campaigns on the same field. For example, the grain size of corn may vary both regionally and seasonally due to different boundary conditions during growth, which may affect the average grain size. For example, a sample tested in the laboratory would be considered effectively processed if it had a CSPS>70%, although there may still be whole grains in the silage. Whole grains cannot be digested by ruminants because the rumen microbes cannot penetrate the husk (pericarp) of the corn kernels and therefore cannot produce lactose from the starch, which is mainly found in the corn kernels. The grains are excreted undigested and the milk yield drops.

Classification into grain components and non-grain components and the subsequent length determination of a long main axis and a short main axis of each classified grain component using the length-width comparison may make it possible to determine the degree of grain cracking, taking crop characteristics into account. The method may take into account the external influences that affect the actual grain size during plant growth. Fluctuations in grain size within a currently processed crop may thus be taken into account. This may improve the accuracy of the calculation of the corn silage processing score (CSPS) based on the optical sifting process. It may enable the mobile determination of the quality value, the CSPS (e.g., directly in a harvesting machine such as a forage harvester) for the evaluation of corn silage, which may reflect the actual grain processing and ultimately may also scale with the milk yield.

In one or some embodiments, the recorded images may be made available to the at least one artificial neural network as an input signal, which may be part of (or work in combination with) the image analysis apparatus.

Various calculations of the degree of grain cracking are contemplated. In particular, the quotient of the sum of the area of classified grain components that fall below an adaptive limit value for the length of the short main axes and the sum of the area of all classified grain components may be formed to calculate the degree of grain cracking.

In one or some embodiments, the use of an adaptive limit value, such as a dynamic one, to determine the degree of grain cracking, taking into account harvested material properties, may take into account the external influences that affect the actual grain size during plant growth. In particular, in one or some embodiments, the limit value may be adapted automatically and/or manually.

In particular, the limit value may be adapted cyclically at intervals (such as at predetermined intervals). Cyclical adaptation may refer to the repeated adaptation of the limit value within a definable or predetermined period of time and/or depending on a definable harvested material throughput or a definable travel distance on a field during the harvesting process.

In one or some embodiments, the image pixels contained in the images may be classified using any one, any combination, or all of semantic image segmentation, object recognition or instance segmentation. A suitable image processing algorithm, such as semantic image segmentation, may be executed by means of the at least one neural network.

In one or some embodiments, the determination of the long main axis and the short main axis of each classified grain component for determining the area may be performed at intervals separated by time.

In particular, a differentiation between whole grains and crushed grains may be performed within the image pixels of a recorded image classified as grain components using segmentation, such as semantic image segmentation. The limit value may be cyclically adjusted such as by adjusting the binary classification, in which a distinction is made between grain components and non-grain components. A multi-class classification may be used to differentiate between whole grains and broken grains within the detected grain components by means of segmentation. In one or some embodiments, an average grain size may be determined via the polygons of the grains classified as “whole grain” using the determined short and long main axis of the grain. An inertia factor, such as time-spaced intervals, may be implemented over the progression of the method so that the mean grain size determined using the length-width comparison is only updated within a selected time window during the harvesting process in relation to all whole grains detected in the interval.

In one or some embodiments, an average value representing the mean grain size for the visible area may be formed from the sum of the area of whole grains determined within the interval, from which the limit value to be adapted may be dynamically derived as a fractional value of the long main axis and/or the short main axis. For example, half of the short and/or long main axis may be used as the fractional value so that the grain is considered to be quartered. Alternatively, other fractional values, such as thirds or fifths of the short and/or long main axis, are also contemplated. The adapted limit value updated in this way may be used as the basis for the image analysis method to determine the degree of grain cracking.

In one or some embodiments, a manual adaptation of the limit value may be performed by selecting from a predefined or predefinable range of values for values of a minimum grain size and a maximum grain size and/or by entering at least one value of an average grain size that is valid for the harvesting process to be performed. The manual adaptation of the limit value may be supported by the image analysis method in such a way that if there is a significant deviation of the calculated mean value representing the mean grain size from the manually specified value, a notification of this may be generated and output for an operator (e.g., the notification may be displayed on a screen, such as a touchscreen of the harvester, for the operator to view). In one or some embodiments, this notification may contain a suggestion for manual adjustment of the limit value. In this regard, the operator may, responsive to the notification on the touchscreen, provide a manual input via the operator agreeing to the suggestion for the manual adjustment of the limit value and/or for inputting another limit value.

It is also contemplated to manually specify the limit value as an initial value, which may be automatically adapted as the harvesting process progresses.

When automatically adjusting the limit value, it is contemplated that a stored or retrievable preset initial value of the limit value may be used at the start of the harvesting process, which may then be adapted as things progress (e.g., during different parts of the harvesting process). For example, within the framework of the documentation for a field, historical data may be accessed, which may contain information on previously cultivated harvested material and past harvesting processes.

In one or some embodiments, an image analysis apparatus for a forage harvester is disclosed, which may comprise an attachment as a working unit configured to pick up or collect harvested material, working units configured to process a flow of harvested material produced from the picked up harvested material, and a driver assistance system which is designed and configured to control the working units. The image analysis apparatus may comprise an optical recording apparatus, which may record (such as cyclically record) images of the processed flow of harvested material and may transmit (e.g., wired and/or wirelessly) the recorded images to the image analysis apparatus for image analysis using an image analysis method in order to determine a degree of grain cracking of grains in the flow of harvested material. The driver assistance system may use the result of the determination of the degree of grain cracking to control (such as automatically control) at least one working unit depending on the degree of grain cracking. In this regard, in one or some embodiments, the driver assistance system may correlate different degrees of grain cracking to different configurations of the working unit(s) (e.g., via a look-up table correlating the different degrees of grain cracking to different configurations of the working unit(s)). In particular, the driver assistance system may determine a respective configuration for the working unit(s) based on the degree of cracking, and may then automatically command the working unit(s) to change its/their configuration to the respective configuration. The image analysis apparatus may be designed and configured to classify image pixels contained in the images into grain components and non-grain components in a first stage of the image analysis method, and in a second stage of the image analysis method, to determine the length of a long main axis and a short main axis of each classified grain component by means of a length-width comparison. In one or some embodiments, the image analysis apparatus comprises at least one neural network for performing the first stage and/or the second stage of the image analysis method.

In particular, the image analysis apparatus may be configured to automatically perform the image analysis methodology as described herein.

In one or some embodiments, the image analysis apparatus is configured to first automatically classify image pixels contained in the images into grain components and non-grain components in binary form, then to automatically determine a length of a long main axis and a short main axis of one, some or each classified grain component using a length-width comparison, and from this to automatically calculate the degree of grain cracking as the quotient of the sum of the area of classified grain components which fall below an adaptive limit value for the length of the short main axis and the sum of the area of all classified grain components.

In one or some embodiments, a forage harvester is disclosed comprising an attachment as the working unit configured to pick up or collect harvested material, working unit(s) configured to process a flow of harvested material produced from the picked up harvested material, a driver assistance system configured to control the working unit(s), an image analysis apparatus configured to automatically perform image analysis using the methodology disclosed herein in order to determine the degree of grain cracking of grains in the flow of harvested material. The driver assistance system may be configured to control (such as automatically control) a working unit designed as a secondary crushing device depending on the determined degree of grain cracking.

In particular, the secondary crushing device may have at least two rollers for breaking up whole grains in the flow of harvested material, each of which may rotate during operation at a rotary speed which may be set as a parameter, wherein a gap with a gap width which may be set as a parameter remains between the rollers and the flow of harvested material runs therethrough, and the rollers have a speed difference which may be set as a parameter and by which the rotary speeds of the rollers differ. The driver assistance system may automatically control at least one, some or each of these parameters depending on the specific degree of grain cracking. For example, the driver assistance system may automatically determine, based on the degree of grain cracking, (such as via a look-up table) values for any one, any combination, or all of: rotary speed for one or both of the at least two rollers; value of the gap for the gap width; or value for the speed different of the at least two rollers. In practice, responsive to the driver assistance system determine the value(s) for one, some or each of the parameters of the secondary crushing device, the driver assistance system may automatically command the secondary crushing device to change its parameter values in order to automatically modify the operation of the secondary crushing device.

In one or some embodiments, the secondary crushing device and the driver assistance system may form an automatic processing unit, wherein the automatic processing unit is configured to automatically optimize the parameters depending on the determined degree of grain cracking and to preset the optimized parameters of the secondary crushing device.

In one or some embodiments, the optical recording apparatus may be arranged or positioned along a harvested material transport path behind the secondary crushing device. Alternatively, or in addition, the optical recording apparatus may be arranged or positioned on a discharge chute of the forage harvester.

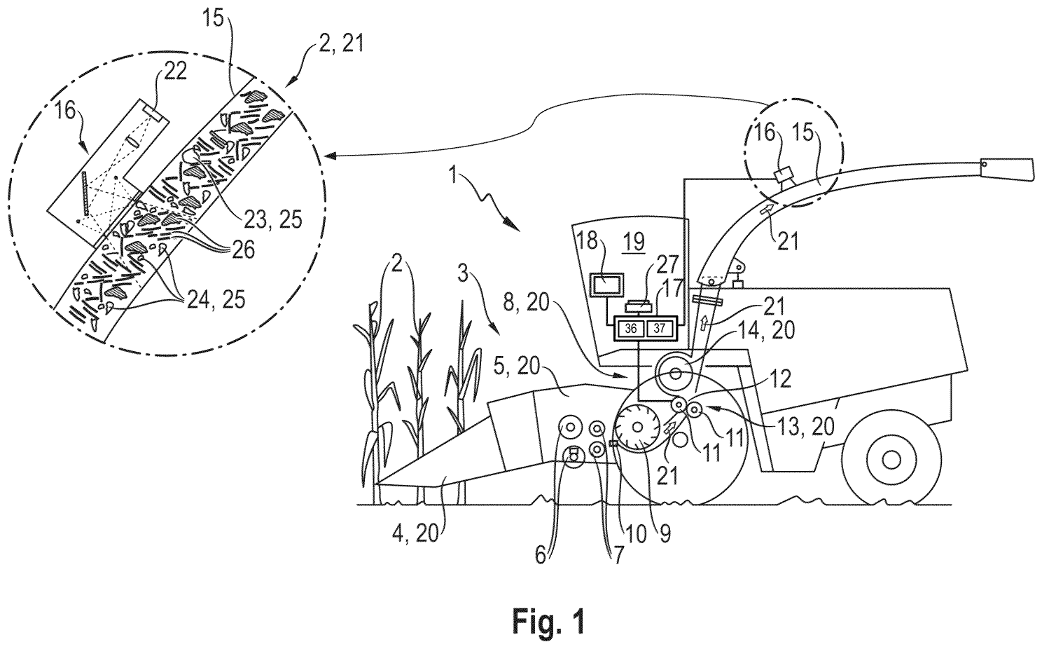

Referring to the figures, FIG. 1 shows, schematically and by way of example, a forage harvester 1 according to one aspect of the invention while harvesting a crop of plants, in particular corn plants 2, on a field. Example forage harvesters are disclosed in US Patent Application No. 2023/0232740 A1 and US Patent Application No. 2022/0071091 A1, both of which are incorporated by reference herein. A pick-up device 3 of the forage harvester 1 comprises, in a manner known per se, an attachment 4 which may be exchanged to be adapted to the plant material to be harvested, and a pulling-in apparatus 5 with may comprise several pairs of rollers 6, 7 and which may take the harvested material from the attachment 4 in order to feed it to a chopping device 8.

The chopping device 8 may comprise a rotationally driven cutterhead 9, a shear bar 10 over which the corn plants 2 are pushed by the adjacent pair of rollers 7 of the pulling-in apparatus 5 in order to be chopped by the interaction of the shear bar 10 with the cutterhead 9. Downstream from the chopping device 8 may be a secondary crushing device 13, which may also be referred to as a corn cracker, with a pair of conditioning or cracker rollers 11, which delimit a gap 12 of adjustable width, hereinafter also referred to as the cracker gap, and rotate at different speeds in order to crush corn kernels contained in the material stream passing through the gap 12. A secondary accelerator 14 may give the shredded harvested material, in this case the corn plants 2, conditioned in the secondary crushing device 13, the necessary speed to pass through a discharge chute 15 and be transferred to an accompanying vehicle (not shown). At least one optical recording apparatus 16 may be arranged or positioned on the discharge chute 15 in order to generate images of a flow of harvested material 21 (illustrated by arrows) conveyed through the discharge chute 15.

Any one, any combination, or all of the attachment 4, the pulling-in apparatus 5, the chopping device 8, the secondary crushing device 13 and the secondary accelerator 14 (or post accelerator) and their particular components may comprise working units 20 of the forage harvester 1, which may serve to harvest the corn plants 2 of a crop and/or to process the corn plants 2 of the crop within the context of the harvesting process.

Within the flow of harvested material 21 processed by the working units 20 of the forage harvester 1 are whole grains 23 and crushed grains 24 as grain components 25 as well as non-grain components 26, such as stalks, leaves and the like.

In one or some embodiments, the optical recording apparatus 16 has at least one camera, such as camera 22, for recording image data of the harvested material 21 of the harvested material flow. In one or some embodiments, the term “camera” may include any optical sensor(s) that record spatially resolved image data. In one or some embodiments, the term “spatially resolved” may mean that it is possible to distinguish details of the harvested material in the image data. The camera 22 therefore may have at least sufficient pixels to enable the disclosed image analysis, which is explained further below. In a measurement routine, the optical recording apparatus 16 may capture image data of the harvested material in the flow of harvested material 21 via the camera 22, such as the chopped corn plants 2. This measuring routine may correspondingly be performed while the forage harvest 1 is operating.

The images generated by the optical recording apparatus 16 may be transmitted (such as wired and/or wirelessly via a wireless transceiver) to an image analysis apparatus 27 and analyzed thereby.

The image analysis apparatus 27 may be connected to (such as in wireless and/or wired communication with) a driver assistance system 17 or may be designed as a component of the driver assistance system 17. The driver assistance system 17 may be connected to an input/output unit 18 (e.g., a touchscreen) in a driver's cab 19 of the forage harvester 1 in order to output evaluation results thereto. In either instance, the image analysis apparatus 27 may transmit information (such as the length of a long main axis 30 and a short main axis 31 of each classified grain component for the driver assistance system 17 to determine the degree of grain cracking or the degree of grain cracking (if the image analysis apparatus 27 itself determines the degree of grain cracking). This transmission of information may be from one separate apparatus to another, in the instance where the image analysis apparatus 27 is separate from the driver assistance system 17, or may be within different components, in the instance where the image analysis apparatus 27 is a component of the driver assistance system 17.

The driver assistance system 17 may include at least one processor 36 and at least one memory 37. In one or some embodiments, the processor 36 may comprise a microprocessor, controller, PLA, or the like. Similarly, the memory 37 may comprise any type of storage device (e.g., any type of memory). Though the processor 36 and the memory 37 are depicted as separate elements, they may be part of a single machine, which includes a microprocessor (or other type of controller) and a memory. Alternatively, the processor 36 may rely on the memory 37 for all of its memory needs. The memory 37 may comprise a tangible computer-readable medium that include software that, when executed by the at least one processor 36 of the driver assistance system 17 is configured to perform any one, any combination, or all of the functionality described herein regarding any computing device.

The processor 36 and the memory 37 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

As discussed above, the image analysis apparatus 27 may be connected to a driver assistance system 17 or may be designed as a component of the driver assistance system 17. When connected to the driver assistance system, the image analysis apparatus 27 may itself have at least one processor and at least one memory configured to perform the operations ascribed to the image analysis apparatus 27 discussed herein. When designed as a component of the driver assistance system 17, the image analysis apparatus 27 may use the processor 36 and the memory 37 of the driver assistance system 17. In either instance, the image analysis apparatus 27 may access at least one memory in order to: access image(s) acquired by the camera 22; and perform its image analysis by accessing one or more methodologies (such as semantic image segmentation, object recognition or instance segmentation as part of at least one neural network). After which, the image analysis apparatus 27 may transmit information (either the degree of grain cracking itself or information in order to determine the degree of grain cracking) to the driver assistance system 17 for the driver assistance system 17 to perform the automatic control based on the degree of grain cracking.

Thus, in one or some embodiments, the driver assistance system 17 may automatically control any one, any combination, or all of: at least one actuator for adjusting the gap width of the cracker gap 12; the differential rotational speed; or the rotational speed levels of the rollers 11 of the secondary crushing device 13.

The rollers 11 of the secondary crushing device 13 may each rotate during operation at a speed settable as a parameter, wherein the gap 12 may remain between the rollers with a gap width settable as a parameter (which may be automatically changed via automatic control by the driver assistance system 17). Furthermore, the rollers 11 may have a rotational speed difference that may be set as a parameter, by which the rotational speeds of the rollers 11 differ (which may be automatically changed via automatic control by the driver assistance system 17). The driver assistance system 17 may automatically control at least one of the parameters depending on a degree of grain cracking CSPSₒₚₜ to be determined by image analysis (e.g., the driver assistance system 17 may automatically select the value(s) for the respective parameters based on the degree of grain cracking CSPSₒₚₜ).

In one or some embodiments, the background to the control of the secondary crushing device 13 depending on the degree of grain cracking is that it may be particularly important when the harvested material is used as feed for animals and/or when used in biogas plants for the grain components 25 of the harvested material to be cracked (e.g., comminuted). It may be important to crack the grain components 25 so that the starch contained therein becomes accessible and is not protected by the husk of the grain component 25. The cracking of grain components 25 may be accomplished on the one hand by chopping up the harvested material and on the other hand substantially by the secondary crushing device 13. The secondary crushing device 13 may be set so that one, some, or all of the grain components 25 are sufficiently chopped, which may be accompanied by increased consumption of energy or fuel. In one or some embodiments, this unnecessarily high consumed energy therefore cannot be converted into an increase in the driving speed so that a system-related, correspondingly reduced output per area results.

The disclosed methodology for computer-implemented determination of the degree of grain cracking of the grains 23 is explained further below. For this purpose, images 28 of the flow of harvested material 21, which may be taken cyclically by the optical recording apparatus 16, may be transmitted to the image analysis apparatus 27 for evaluation using an image analysis method.

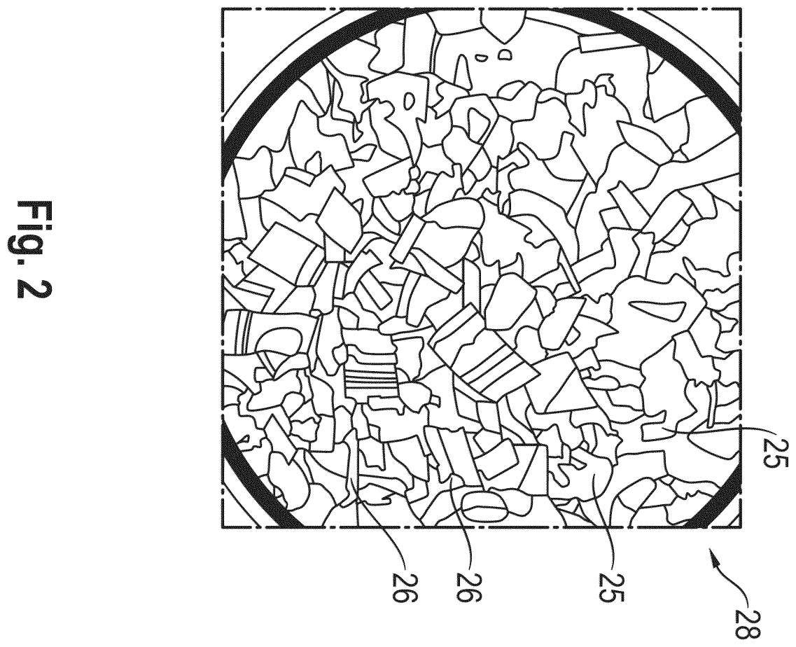

FIG. 2 shows a shows a schematic and example image 28 of chopped harvested material, in this case the corn plant 2, taken by the optical recording apparatus 16. In the image 28 taken by the optical recording apparatus 16, the grain components 25 and non-grain components 26 of the chopped corn plant 2 are visible. The recognition of grain components 25 and the differentiation of whole grains 23 from chopped grains 24 may only be possible to a very limited extent using such an image 28.

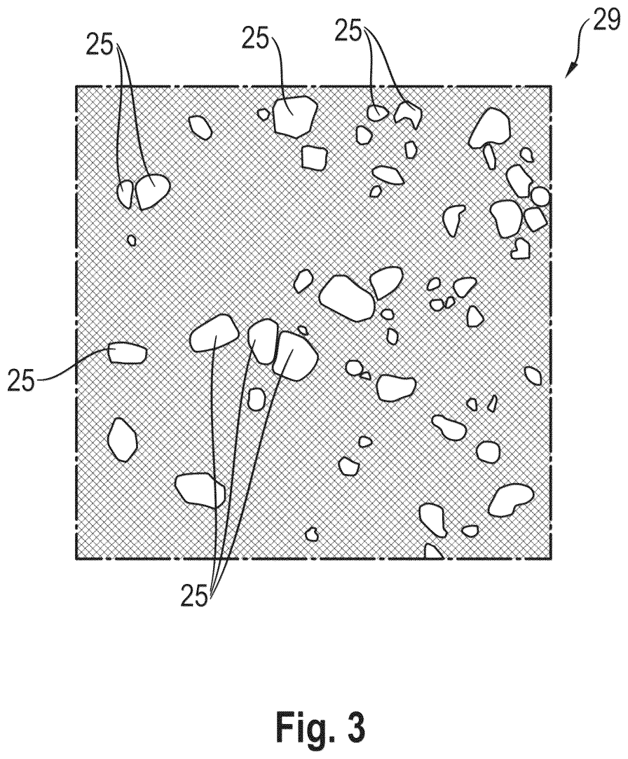

FIG. 3 shows a shows a schematic and exemplary binary image 29 of the image 28 processed by an image processing algorithm according to FIG. 2. The binary image 29 generated by semantic segmentation may only show grain components 25, while all non-grain components 26 visible in the image 28 may not be shown. For this purpose, the detected grain components 25 may be displayed in white, for example, while the detected non-grain components 26 are displayed uniformly (e.g., in black) so that the detected non-grain components 26 form a uniform background of the visualization in the binary image 29.

In a first stage of the image analysis method, pixels contained in the images 28 taken by the optical recording apparatus 16 may be classified into grain components 25 and non-grain components 26. This may be performed here using semantic image segmentation. Other computer-implemented methods of computer-based vision that may be used for image analysis are, for example, object recognition or instance segmentation.

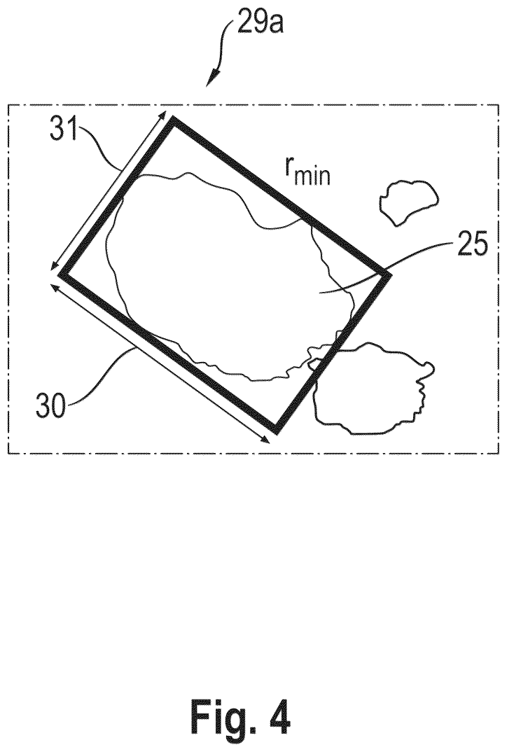

In a second stage of the image analysis method, a length determination of a long main axis 30 and a short main axis 31 of one, some, or each classified grain component 25 is performed by means of a length-width comparison, as shown in FIG. 4 as an example.

FIG. 4 shows a schematic and exemplary enlarged section 29a of the binary image 29 according to FIG. 3. The largest value rₘᵢₙ determined for the length of the short main axis 31 of each grain component 25 may be used as the basis for the subsequent method.

In one or some embodiments, the first stage and the second stage of the image analysis method are performed by at least one neural network. The at least one neural network may be a component of the image analysis apparatus 27.

The determination of the long main axis 30 and the short main axis 31 of each classified grain component 25 for determining the area is performed, such as cyclically at time-spaced intervals.

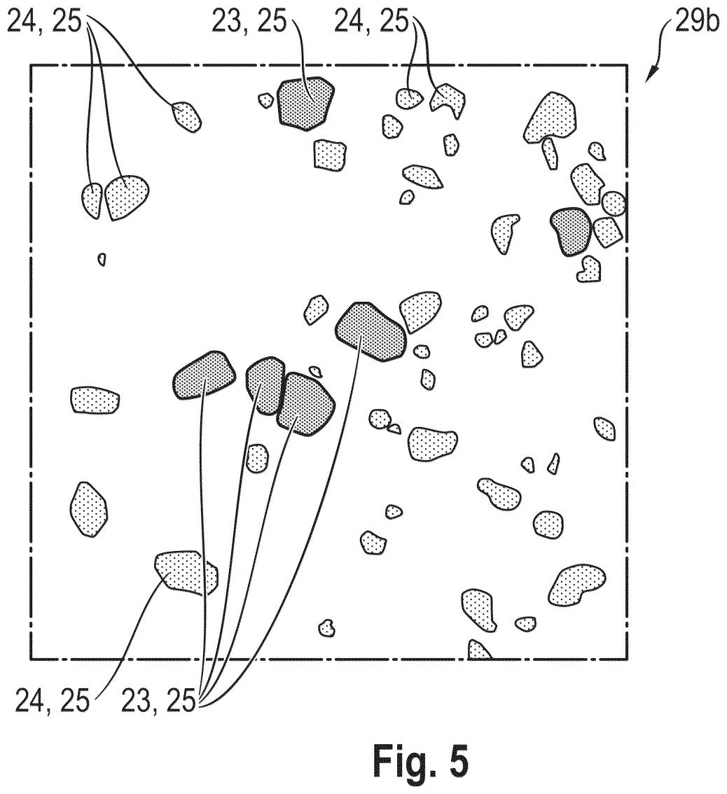

FIG. 5 illustrates a schematic and an example extended evaluation of the binary image 29 according to FIG. 3. A multi-class classification using semantic image segmentation may be used to generate an image 29b in which a distinction is made between the whole grains 23 as one class of multi-class classification and the crushed grains 24 as a further class of multi-class classification.

In one or some embodiments, the multi-class classification may be used to determine an average grain size. This may be seen against the background that corn plants 2 from different regions and/or harvest years have different average grain sizes, which may have an influence on the determination of the degree of grain cracking.

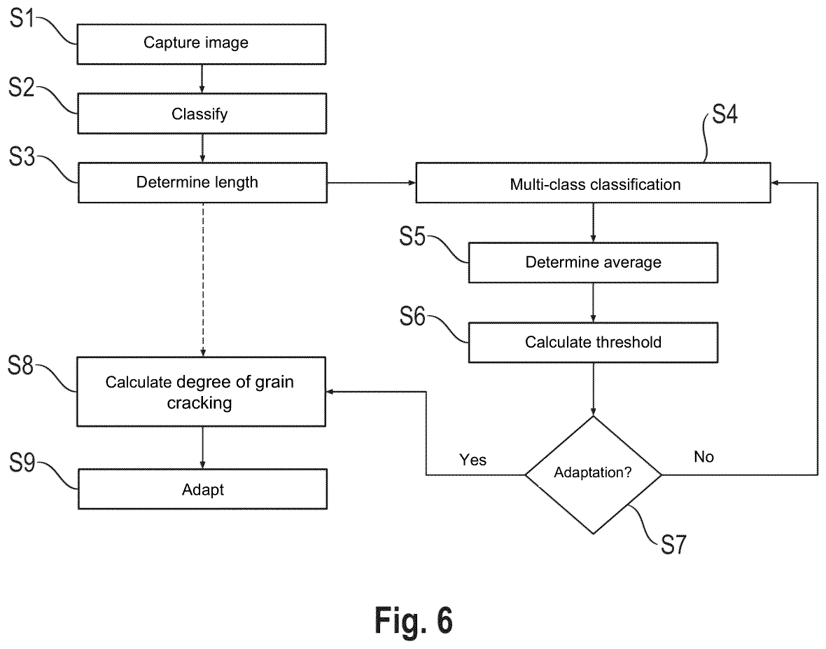

FIG. 6 illustrates the image analysis method using a flow chart as an example. The image analysis method begins in step S1 with the image 28 being recorded by the optical recording apparatus 16, which is transmitted to the image analysis apparatus 27.

In step S2, the image 28 is classified using semantic segmentation in order to generate the binary image 29. The grain components 25 and non-grain components 26 may be classified on the basis of the image pixels contained in the respective image 28. The binary image 29 generated in this way corresponding to the image 28 may only contain information about the grain components 25.

In step S3, the length of the long main axis 30 and the short main axis 31 of each classified grain component 25 is determined by means of the length-width comparison. Using binarization, the visible surface of the respective grain component 25 may be determined from the grain components 25 determined in this way using just the number of pixels, and the length determination of the long main axis 30 and the short main axis 31 may also be performed.

The calculation of the degree of grain cracking CSPSₒₚₜ the basis of the image evaluation is generally carried out according to the following equation [1].

$$C S P {S}_{opt} = \frac{Σ {A}_{K B} ( {r}_{31} < {r}_{min} )}{{A}_{K B G}} . \qquad Eq . [ 1 ]$$

In this equation, CSPSₒₚₜ may denote the degree of grain cracking determined by optical sifting, rₘᵢₙ a limit value for the maximum length of the short main axis 31 of the detected grain components 25, A_{KB} the visible area of grain components 25 whose length of the short main axis 31 is less than the limit value rₘᵢₙ, and A_{KBG} the visible area of all detected grain components 25. The limit value rₘᵢₙ corresponds to a sieve opening width of an optical sieve. If grain components 25 pass through this optical sieve opening width (e.g., if a maximum length r₃₁ of the short main axis 31 of a grain component 25 falls below the limit value rₘᵢₙ), the detected grain component 25 may correspond to a crushed grain 24. The limit value rₘᵢₙ may correspond to the limit value of 4.75 mm on which laboratory tests according to the prior the art are based.

In order to be able to react to fluctuations in the actual grain size during the harvesting process to be performed, the calculation of the degree of grain cracking CSPSₒₚₜ is performed according to the following equation [2].

$$C S P {S}_{opt} = \frac{Σ {A}_{K B} ( {r}_{31} < {r}_{a d a p t} )}{{A}_{K B G}} \qquad Eq . [ 2 ]$$

Here, r_{adapt} refers to an adaptive limit value for the maximum length r₃₁ of the short main axis 31 which, when exceeded, classifies the respective grain component 25 as a whole grain 23 and which, when undershot, classifies the respective grain component 25 as a crushed grain 24.

In one or some embodiments, the adaptive limit value r_{adapt} is not kept constant during the course of a harvesting process, but is adjusted cyclically in order to be able to react to fluctuations in the actual grain size.

The use of the adapted limit value r_{adapt} (such as dynamically adapted limit value r_{adapt}) to determine the adaptive degree of grain cracking CSPSₒₚₜ, taking into account changing crop properties, may take into account the external influences that affect the actual grain size during plant growth. This may mean that the degree of grain cracking CSPSₒₚₜ may be dynamically adapted to the actual harvesting conditions, which may have an advantageous effect on the control of working units 20, in particular the secondary crushing device 13, of the forage harvester 1.

In one or some embodiments, the adaptive limit value r_{adapt} may be adapted cyclically at intervals. In one or some embodiments, cyclically adapting may mean repeatedly adapting the limit value r_{adapt} within a definable period of time and/or depending on a definable harvested material throughput or a definable travel distance on a field during the harvesting process to be carried out.

For this purpose, in step S4, the multi-class classification may be performed as described above with reference to FIG. 5. In step S4, an additional distinction may be made between the whole grains 23 and the crushed grains 24 as grain components 25.

The length determination of the long main axis 30 may be performed in step S3 and the short main axis 31 of each classified whole grain 23 as a grain component 25 may be evaluated in step S5. A mean value A_{mKB} representing the mean area of the whole grains 23 may be performed in step S5 from the sum of the area A_{KB} of whole grains 23 determined within the in particular time interval. This mean value A_{mKB} may be used as a criterion for the mean grain size. In one or some embodiments, the mean grain size may be determined via the polygons of the grain components 25 classified as “whole grain 23” using the determined short main axis 31 and long main axis 30 of the whole grain 23. An inertia factor, the time-spaced intervals, may be implemented over the progression of the method so that the mean grain size determined using the length-width comparison may only be updated within a selected time window in relation to all whole grains 23 detected in the interval.

$${A}_{m K B} = \frac{Σ {A}_{K B}}{B} \qquad Eq . [ 3 ]$$

The mean value A_{mKB} formed from the mean area of the whole grains 23 may be representative of the actual grain size of the processed harvested material. The adaptive limit value r_{adapt} may then be dynamically derived in step S6 from the mean value A_{mKB} as a fractional value B of the long main axis 30 and/or the short main axis 31 (see equation [4]).

$${r}_{adapt} = \frac{{A}_{m K B}}{B} \qquad Eq . [ 4 ]$$

For this purpose, in step S6, the calculated adaptive limit value r_{adapt} is formed as the quotient of the mean value A_{mKB} and the fractional value B. Half of the short main axis 31 and/or the long main axis 30 may be used as the fractional value, so that the processed grain component 25 is regarded as quartered. Alternatively, other fractional values B, such as thirds or fifths of the short main axis 31 and/or the long main axis 30, are also contemplated.

In step S7, the limit value r_{adapt} used in a previous interval may then be compared with the adaptive limit value r_{adapt} calculated in step S6. If there is a deviation, the limit value r_{adapt} calculated in step S6 may be used when performing the calculation in step S8.

The adaptive limit value r_{adapt} may be adapted automatically and/or manually.

When automatically adjusting the limit value r_{adapt}, it is contemplated that a stored or retrievable preset initial value of the limit value r_{adapt}, e.g. the limit value rₘᵢₙ, is used at the start of the harvesting process, which may then be adapted as things progress. For example, within the framework of the documentation for a field, historical data may be accessed which may contain information on previously cultivated harvested material and past harvesting processes.

In one or some embodiments, the secondary crushing device 13 and the driver assistance system 17 may form an automatic processing unit. The automatic processing unit may be designed and configured to optimize the parameters for controlling the secondary crushing device 13 depending on the determined degree of grain cracking CSPSₒₚₜ, and to specify the optimized parameters to the at least one actuator for setting the gap width of the cracker gap 12 and/or the differential rotary speed and/or the rotary speed levels of the rollers 11 of the secondary crushing device 13.

In step S9, the determined value for the degree of grain cracking CSPSₒₚₜ may be transmitted to the driver assistance system 17. In one or some embodiments, the driver assistance system 17 may use the value determined in accordance with the method for the degree of grain cracking CSPSₒₚₜ to automatically control at least the secondary crushing device 13 depending thereon. The automatic processing unit formed by the secondary crushing device 13 and the driver assistance system 17 may be configured to optimize at least one of the parameters of the secondary crushing device 13 depending on the determined degree of grain crushing CSPSₒₚₜ and to specify (such as via one or more commands) the secondary crushing device 13 for the at least one actuator (e.g., responsive to receiving the one or more commands, the secondary crushing device 13 may control the at least one actuator in order to automatically control the at least one parameter, such as the at least one parameter indicative of rotary speed, the at least one parameter indicative of a gap width, and/or the at least one parameter indicative of a speed difference. This may allow the efficiency and quality of the shredding process to be improved.

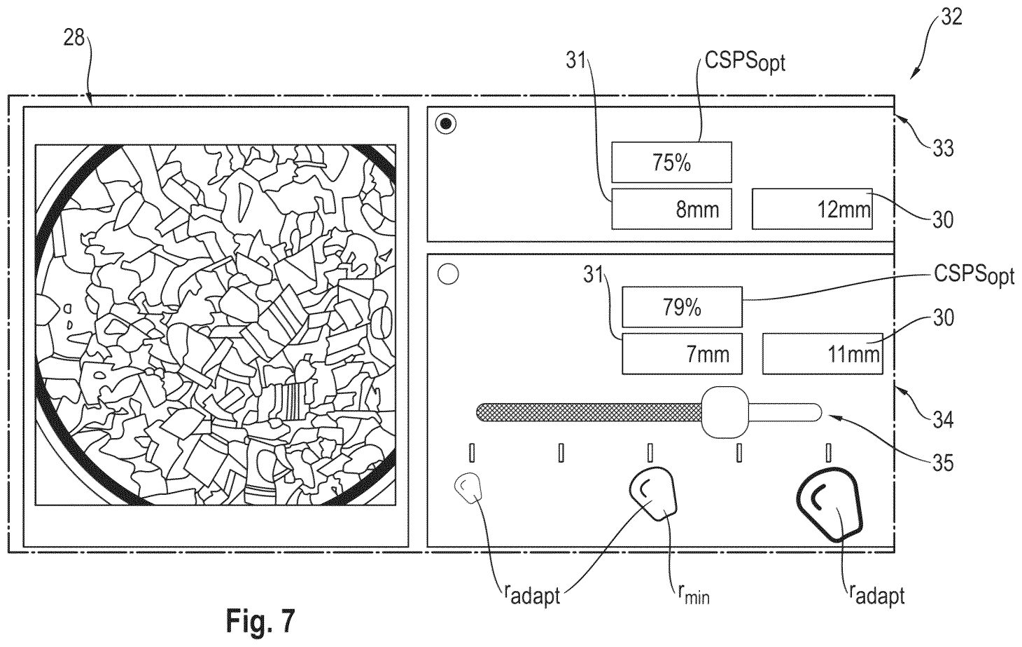

FIG. 7 shows a schematic and example representation of a graphical interface 32 of an input/output unit 18 of a driver assistance system 17. In one or some embodiments, the input/output unit 18 is designed as a touch-sensitive screen.

In one or some embodiments, the graphic interface 32 is designed to display, on one side of the screen, one of the images 28 of chopped harvested material recorded by the optical recording apparatus 16. A first control panel 33 and a second control panel 34 may be visualized on the opposite side. In the first control panel 33, the data may be continuously updated in accordance with equation [2] when the adaptive limit value r_{adapt} and the thereby determined degree of grain cracking CSPSₒₚₜ may be automatically adapted. Furthermore, values for the determined length of the long main axis 30 and the short main axis 31 may be automatically determined in step S4 of the method according to one or more aspects of the invention during the multi-class classification. Some or all information displayed in the first control panel 33 may be continuously updated.

In one or some embodiments, in the second control panel 34, it may be possible to manually adjust the adaptive limit value r_{adapt}. This second control panel may also display and/or continuously update certain values for the length of the long main axis 30 and the short main axis 31, which may be determined automatically in step S4 of the method according to one aspect of the invention during the multi-class classification. The limit value r_{adapt} may be set or preset manually by the user. An initial value for the manually presettable limit value r_{adapt} may be the limit value rₘᵢₙ, which is used in laboratory tests to determine the degree of grain cracking.

This manually adapted value for the limit value r_{adapt} may be used as the basis for calculating the degree of grain cracking CSPSₒₚₜ in accordance with equation [2]. The calculation and display of the degree of grain cracking CSPSₒₚₜ determined according to equation [2] may also be performed cyclically. The display of the degree of grain cracking CSPSₒₚₜ may be continuously updated if deviations occur. A change in the manually presettable limit value r_{adapt} may be performed using a slider 35, for example. The position of the slider 35 is intended to visualize to the operator of the forage harvester 1 that the operator is selecting larger or smaller whole grains 23 as the basis for calculating the degree of grain cracking CSPSₒₚₜ in accordance with equation [2]. Alternative input elements instead of a slider 35 are contemplated.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| | |
|---|---|
| 1 | Forage harvester |
| 2 | Corn plant |
| 3 | Pick-up device |
| 4 | Attachment |
| 5 | Pulling-in apparatus |
| 6 | Roller pair |
| 7 | Roller pair |
| 8 | Chopping device |
| 9 | Cutterhead |
| 10 | Shear bar |
| 11 | Conditioning or cracker roller |
| 12 | Gap |
| 13 | Secondary crushing device |
| 14 | Secondary accelerator |
| 15 | Discharge chute |
| 16 | Detection apparatus |
| 17 | Driver assistance system |
| 18 | Input/output unit |
| 19 | Driver's cab |
| 20 | Work unit |
| 21 | Harvested material flow |
| 22 | Camera |
| 23 | Whole grains |
| 24 | Crushed grains |
| 25 | Grain component |
| 26 | Not grain component |
| 27 | Image analysis apparatus |
| 28 | Image |
| 29 | Binary image |
| 29a | Enlarged section of 29 |
| 29b | Image |
| 30 | Long main axis |
| 31 | Short main axis |
| 32 | Graphical interface |
| 33 | First control panel |
| 34 | Second control panel |
| 35 | Slider |
| 36 | Processor |
| 37 | Memory |
| CSPSₒₚₜ | Degree of grain cracking |
| r_{adapt} | Limit value |
| rₘᵢₙ | Limit value |

1. An image analysis method for a computer-implemented determination of a degree of grain cracking of grains within a flow of harvested material processed by at least one working unit of a forage harvester, the flow comprises whole grains and crushed grains as grain components and non-grain components, wherein the at least one working unit is automatically controlled depending on the determined degree of grain cracking, the method comprising:
obtaining, using at least one optical recording device, one or more images of the flow of harvested material;
in a first stage of the image analysis method, classifying image pixels contained in the one or more images into grain components and non-grain components;
in a second stage of the image analysis method, performing, using a length-width comparison, a length determination of a long main axis and a short main axis of one or more of the classified grain components, wherein at least one neural network performs the first stage and the second stage;
determining, using the length determination, the degree of grain cracking; and
automatically controlling the at least one working unit based on the degree of grain cracking.

2. The method of claim 1, wherein determining, using the length determination, the degree of grain cracking comprises:
determining an area of classified grain components that fall below an adaptive limit value for the length of the short main axis.

3. The method of claim 2, wherein determining, using the length determination, the degree of grain cracking comprises:
calculating a quotient of a sum of the area of classified grain components that fall below the adaptive limit value for the length of the short main axis and a sum of an area of all classified grain components; and
calculating, based on the quotient, the degree of grain cracking.

4. The method of claim 3, further comprising automatically adapting the adaptive limit value.

5. The method of claim 4, wherein the adaptive limit value is automatically adapted cyclically at intervals based on one or both of the long main axis or the short main axis.

6. The method of claim 3, wherein a differentiation between whole grains and crushed grains is performed within the image pixels classified as grain components of a recorded image using semantic image segmentation.

7. The method of claim 6, wherein an average value representing a mean size of the grains is formed for a visible area from the sum of the area of whole grains determined within an interval, from which the adaptive limit value is dynamically derived as a fractional value of one or both of the long main axis or the short main axis.

8. The method of claim 2, further comprising manually adapting the adaptive limit value.

9. The method of claim 8, wherein manually adapting the adaptive limit value is performed by one or both of:
a selection from a predefined or predefinable range of values for values of an average grain size; or
by an input of at least one value of an average grain size.

10. The method of claim 2, wherein the one or more images are cyclically recorded and transmitted to an image analysis apparatus for evaluation; and
wherein the image pixels contained in the one or more images are classified using at least one of semantic image segmentation, object recognition or instance segmentation.

11. The method of claim 2, wherein determining the long main axis and the short main axis of each classified grain component, in order to determine the area of the classified grain components that fall below the adaptive limit value for the length of the short main axes, is performed at time-spaced intervals.

12. An image analysis apparatus for a forage harvester that comprises an attachment as a working unit configured to pick up harvested material, at least one working unit configured to process a flow of harvested material produced from the harvested material, and a driver assistance system configured to control the at least one working unit, the image analysis apparatus configured to:
receive one or more images generated by an optical recording apparatus;
in a first stage, classify image pixels contained in the one or more images into grain components and non-grain components;
in a second stage, determine a length of a long main axis and a short main axis of each classified grain component using a length-width comparison in order to determine a degree of grain cracking, wherein at least one neural network is configured to perform the first stage and the second stage; and
transmit, to the driver assistance system, the degree of grain cracking of grains in the flow of harvested material in order for the driver assistance system to automatically control, based on the degree of grain cracking, the at least one working unit.

13. The image analysis apparatus of claim 12, wherein the image analysis apparatus is configured to determine, using the length determination, the degree of grain cracking by:
determining an area of classified grain components that fall below an adaptive limit value for the length of the short main axis.

14. The image analysis apparatus of claim 13, wherein the image analysis apparatus is further configured to automatically adapt the adaptive limit value based on one or both of the long main axis or the short main axis.

15. A forage harvester comprising:
an attachment configured to collect harvested material;
one or more working units configured to process a stream of the harvested material produced from the harvested material that is collected, the one or more working units comprise a secondary crushing device;
an optical recording apparatus configured to generate one or more images of flow of harvested material;
an image analysis apparatus configured to determine a degree of grain cracking of grains in the flow of the harvested material by:
in a first stage of, classifying image pixels contained in the one or more images into grain components and non-grain components;
in a second stage, performing, using a length-width comparison, a length determination of a long main axis and a short main axis of one or more of the classified grain components, wherein at least one neural network performs the first stage and the second stage; and
determining, using the length determination, the degree of grain cracking; and
a driver assistance system configured to automatically control, based on the degree of grain cracking, the secondary crushing device.

16. The forage harvester of claim 15, wherein the secondary crushing device has at least two rollers for breaking up whole grains in the flow of harvested material, wherein the secondary crushing device is configured to receive one or more commands in order to set one or more of the following parameters:
at least one parameter indicative of rotary speed, wherein each of the at least two rollers configured to rotate during operation at the rotary speed;
at least one parameter indicative of a gap width, wherein the gap width is a gap between the at least two rollers; and
at least one parameter indicative of a speed difference, wherein the at least two rollers have the speed difference by which the rotary speeds of the at least two rollers differ; and
wherein the driver assistance system is configured to automatically generate, based on a specific degree of grain cracking, and send to the secondary crushing device the one or more commands in order to automatically control the at least one parameter indicative of the rotary speed, the gap width, or the speed difference.

17. The forage harvester of claim 16, wherein the secondary crushing device and the driver assistance system form an automatic processing unit;
wherein the automatic processing unit is configured to optimize the at least one parameter indicative of the rotary speed, the gap width, or the speed difference depending on the determined degree of grain cracking and to preset optimized parameters of the secondary crushing device.

18. The forage harvester of claim 15, wherein the optical recording apparatus is positioned along a harvested material transport path behind the secondary crushing device.

19. The forage harvester of claim 18, wherein the optical recording apparatus is positioned on a discharge chute of the forage harvester.
